(19) United States
(12) Patent Application Publication
(10) Pub. No.: US 2026/0038048 A1
(43) Pub. Date: Feb. 5, 2026

(54) Technologies for Enterprise Financial Modeling

(71) Applicant: The PNC Financial Services Group, Inc., Pittsburgh, PA (US)

(72) Inventors: Kimberlene Matthews, Chicago, IL (US); Vincent Klos, Chicago, IL (US); Irina Pachecho, Chicago, IL (US); Kyle Lee, Chicago, IL (US)

(21) Appl. No.: 19/273,266

(22) Filed: Jul. 18, 2025

Related U.S. Application Data
(60) Provisional application No. 63/677,482, filed on Jul. 31, 2024.

(51) Int. Cl. G06Q 40/06

(52) U.S. Cl. CPC G06Q 40/067; G06Q 40/0631

(57) ABSTRACT

Technologies for enterprise financial modeling include a system with circuitry configured obtain parameter data indicative of a financial status of an organization. The circuitry may be further configured to select, as a function of the parameter data and from a set of models for tracking key financial metrics of different types of organizations, a model. Additionally, the circuitry may be configured to simulate, using the selected model and by dynamically allocating compute resources across multiple compute devices as a function of a simulation compute load, an effect of a predicted performance of a set of investments on the financial status of the organization. Other embodiments are also described and claimed.

### RELATED APPLICATIONS

This application claims the benefit of U.S. Provisional Application No. 63/677,482filed Jul. 31, 2024 for “Technologies for Enterprise Financial Modeling,” which is hereby incorporated by reference in its entirety.

### BACKGROUND

In operation, organizations of differing types have differing financial goals that affect their ability to continue their operations and grow. For example, some organizations may rely on cash flow to fund immediate operations while others seek to maximize a ratio of assets to liabilities. Accordingly, investments that may be suitable for some organizations may be less suitable for other organizations. Further, given the level of variability in operations and financial goals of different organizations, as well as the variability in potential outcomes for different investments, conventional systems may be unable to efficiently model the effect that certain investments will have on the financial status of an organization.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements. The detailed description particularly refers to the accompanying figures in which:

FIG. 1 is a simplified block diagram of at least one embodiment of a system for enterprise financial modeling;

FIG. 2 is a simplified block diagram of at least one embodiment of a compute device of the system of FIG. 1;

FIGS. 3-8 are flowcharts of at least one embodiment of a method for enterprise financial modeling that may be performed by the system of FIG. 1;

FIG. 9 is a chart of an income statement with historical, present, and projected financial data that may be utilized by the system of FIG. 1;

FIG. 10 is a chart of key financial metrics that may be modeled in connection with a set of investments for an organization by the system of FIG. 1; and

FIG. 11 is a diagram of an embodiment of a user interface that may be produced by the system of FIG. 1 to represent probabilities associated with possible outcomes for investments associated with an organization.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

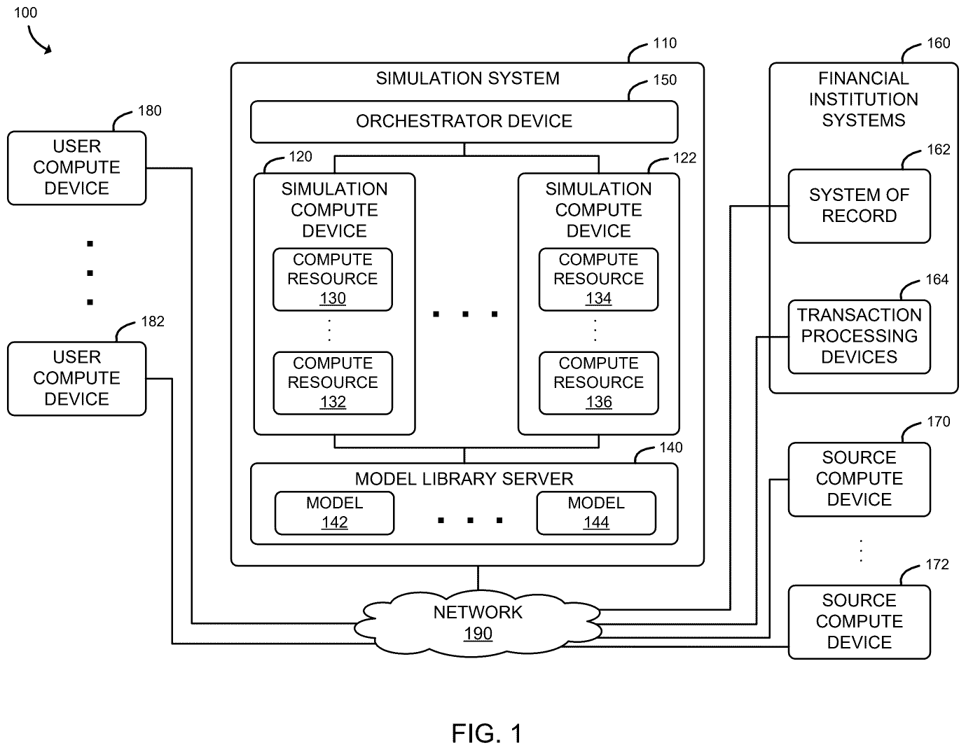

Referring now to FIG. 1, a system 100 for enterprise financial modeling includes a simulation system 110 with a set of simulation compute devices 120, 122. Each simulation compute device 120, 122 includes a corresponding set of compute resources 130, 132, 134, 136, each of which may be embodied as a processor, a core, a hardware thread (e.g., each a separate execution context including a separate, isolated set of registers, page tables, and/or other microarchitectural components used to separately track the state of and execute a corresponding set of operations). In some embodiments, one or more of the compute resources 130, 132, 134, 136 may be virtualized (e.g., formed by a subset or a combination of the compute capacity of underlying hardware and exposed through an abstraction layer as hardware, such as in a virtualized environment (e.g., a virtual machine)). In operation, the simulation compute devices 120, 122 obtain financial data associated with an organization (also referred to herein as an enterprise), including identifying key financial metrics that are indicative of the financial health (e.g., financial status) and that may be indicative of the financial goals of the organization. Further, the simulation compute devices 120, 122 simulate the effect of possible outcomes for a set of investments on the financial health of the organization (e.g., whether the outcomes will positively or adversely impact the key financial metrics, whether the outcomes indicate that the financial goals will be met, etc.). In doing so, the simulation compute devices 120, 122 may select a corresponding model 142, 144 from a model library server 140 (e.g., a compute device that maintains and provides access to a data structure, such as a database, of rules-based models (e.g., algorithms, decision trees, etc.), machine learning models (e.g., neural networks), or other sets of data and/or instructions) to simulate the performance of the set of investments on the finances of the corresponding organization. Each model 142, 144, in the illustrative embodiment, is configured (e.g., through selection and preprocessing of input parameters, weights, algorithms, etc.) to calculate the impact on the key financial metrics for the corresponding type of organization (e.g., insurance, higher education, non-profit, healthcare, etc.).

Still referring to FIG. 1, the simulation system 110, in the illustrative embodiment, includes an orchestrator device 150 which may be embodied as any device or circuitry configured to monitor the compute loads of the simulation compute devices 120, 122 and assign tasks (e.g., simulation of outcomes using a corresponding model 142, 144) to the simulation compute devices 120, 122 based on a demand for simulations and on the availability of compute resources 130, 132, 134, 136 at any given time. In some embodiments, the orchestrator device 150 may assign tasks among the simulation compute devices 120, 122 further as a function of suitability of the compute resources to the model 142, 144. For example, some models may benefit from accelerated matrix multiplication operations, which certain compute resources 130, 132, 134, 136 may be more able to readily provide (e.g., based on their underlying architecture, such as graphic processing units (GPUs) or neural processing units (NPUs)), while other models may benefit from branch prediction, high precision processing units (e.g., floating point units (FPUs)), or other features, which other compute resources 130, 132, 134, 136 may be more suited to provide.

As described in more detail herein, in at least some embodiments, the simulation system 110 is operated by a financial institution and may obtain data from other systems 160 of the financial institution, such as from a system of record 162 or one or more transaction processing devices 164. For example, the simulation system 110 may obtain data indicative of investments and performance of the investments associated with a pension plan of an organization and may combine that data with other data analyzed with a model 142, 144 to provide a holistic view of possible effects on the financial health of the organization. In performing the operations, the simulation system 110 may obtain data from other sources (e.g., source compute devices 170, 172), such as data indicative of historical trends and present performance of each of multiple types of assets (e.g., stocks, bonds, etc.) and/or data from the organization itself (e.g., financial records, such as income statements). In the illustrative embodiment, the simulation system 110 may provide an interface (e.g., a user interface) to one or more user compute devices 180, 182 to obtain data (e.g., data indicative of finances of the organization, data indicative of financial goals of the organization, etc.) used to perform the above-described analysis and to present results of the analysis (e.g., in one or more spreadsheets and/or graphical formats, such as charts or graphs).

While a relatively small number of compute devices 110, 120, 122, 140, 162, 164, 170, 172, 180, 182 are shown in FIG. 1 for simplicity and clarity, it should be understood that the number of compute devices, in practice, may range in the tens, hundreds, thousands, or more. Likewise, it should be understood that the compute devices 110, 120, 122, 140, 162, 164, 170, 172, 180, 182 may be distributed differently or perform different roles than the configuration shown in FIG. 1. Further, though shown as separate compute devices 110, 120, 122, 140, 162, 164, 170, 172, 180, 182, in some embodiments, the functionality of one or more of the compute devices 110, 120, 122, 140, 162, 164, 170, 172, 180, 182 may be combined into fewer compute devices and/or distributed across more compute devices than those shown in FIG. 1.

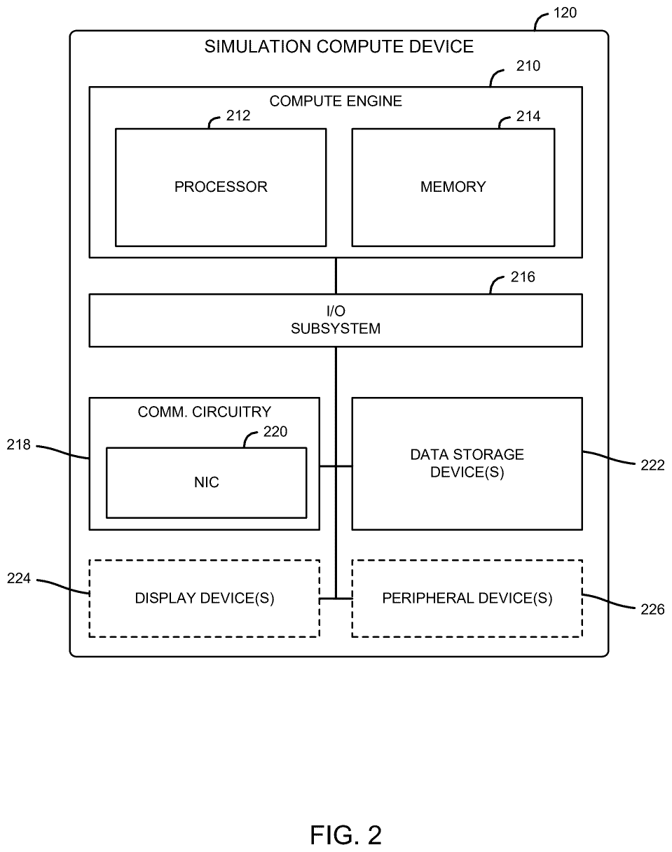

Referring now to FIG. 2, an illustrative embodiment of a simulation compute device 120 includes a compute engine 210, an input/output (I/O) subsystem 216, communication circuitry 218, and one or more data storage devices 222. In some embodiments, the simulation compute device 120 may include one or more display devices 224 and/or one or more peripheral devices 226 (e.g., a mouse, a physical keyboard, etc.). In some embodiments, one or more of the illustrative components may be incorporated in, or otherwise form a portion of, another component. The compute engine 210 may be embodied as any type of device or collection of devices capable of performing various compute functions described below, and corresponds with the compute resources 130, 132 described with reference to FIG. 1. In some embodiments, the compute engine 210 may be embodied as a single device such as an integrated circuit, an embedded system, a field-programmable gate array (FPGA), a system-on-a-chip (SOC), or other integrated system or device. Additionally, in the illustrative embodiment, the compute engine 210 includes or is embodied as at least one processor 212 and a memory 214. The processor 212 may be embodied as any type of processor capable of performing the functions described herein. For example, the processor 212 may be embodied as a single or multi-core processor(s), a microcontroller, or other processor or processing/controlling circuit. In some embodiments, the processor 212 may be embodied as, include, or be coupled to an FPGA, an application specific integrated circuit (ASIC), one or more graphics processing units (GPUs), neural processing units (NPUs), and/or floating point units (FPUs), reconfigurable hardware or hardware circuitry, or other specialized hardware to facilitate performance of the functions described herein.

In embodiments, the processor 212 is capable of receiving, e.g., from the memory 214 or via the I/O subsystem 216, a set of instructions which when executed by the processor 212 cause the simulation compute device 120 to perform one or more operations described herein. In embodiments, the processor 212 is further capable of receiving, e.g., from the memory 214 or via the I/O subsystem 216, one or more signals from external sources, e.g., from the peripheral devices 226 or via the communication circuitry 218 from an external compute device, external source, or external network. As one will appreciate, a signal may contain encoded instructions and/or information. In embodiments, once received, such a signal may first be stored, e.g., in the memory 214 or in the data storage device(s) 222, thereby allowing for a time delay in the receipt by the processor 212 before the processor 212 operates on a received signal. Likewise, the processor 212 may generate one or more output signals, which may be transmitted to an external device, e.g., an external memory or an external compute engine via the communication circuitry 218 or, e.g., to one or more display devices 224. In some embodiments, a signal may be subjected to a time shift in order to delay the signal. For example, a signal may be stored on one or more storage devices 222 to allow for a time shift prior to transmitting the signal to an external device. One will appreciate that the form of a particular signal will be determined by the particular encoding a signal is subject to at any point in its transmission (e.g., a signal stored will have a different encoding than a signal in transit, or, e.g., an analog signal will differ in form from a digital version of the signal prior to an analog-to-digital (A/D) conversion).

The main memory 214 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. In some embodiments, all or a portion of the main memory 214 may be integrated into the processor 212. In operation, the main memory 214 may store various software and data used during operation such as models, configuration data, applications, libraries, and drivers.

The compute engine 210 is communicatively coupled to other components of the simulation compute device 120 via the I/O subsystem 216, which may be embodied as circuitry and/or components to facilitate input/output operations with the compute engine 210 (e.g., with the processor 212 and the main memory 214) and other components of the simulation compute device 120. For example, the I/O subsystem 216 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 216 may form a portion of a system-on-a-chip (SoC) and be incorporated, along with one or more of the processor 212, the main memory 214, and other components of the simulation compute device 120, into the compute engine 210.

The communication circuitry 218 may be embodied as any communication circuit, device, or collection thereof, capable of enabling communications over a network between the simulation compute device 120 and another device (e.g., a compute device 110, 122, 140, 162, 164, 170, 172, 180, 182, etc.). The communication circuitry 218 may be configured to use any one or more communication technology (e.g., wired or wireless communications) and associated protocols (e.g., Ethernet, Wi-Fi®, WiMAX, Bluetooth®, etc.) to effect such communication.

The illustrative communication circuitry 218 includes a network interface controller (NIC) 220. The NIC 220 may be embodied as one or more add-in-boards, daughter cards, network interface cards, controller chips, chipsets, or other devices that may be used by the simulation compute device 120 to connect with another compute device (e.g., a compute device 110, 122, 140, 162, 164, 170, 172, 180, 182, etc.). In some embodiments, the NIC 220 may be embodied as part of a system-on-a-chip (SoC) that includes one or more processors, or included on a multichip package that also contains one or more processors. In some embodiments, the NIC 220 may include a local processor (not shown) and/or a local memory (not shown) that are both local to the NIC 220. Additionally or alternatively, in such embodiments, the local memory of the NIC 220 may be integrated into one or more components of the simulation compute device 120 at the board level, socket level, chip level, and/or other levels.

Each data storage device 222, may be embodied as any type of device configured for short-term or long-term storage of data such as, for example, memory devices and circuits, memory cards, hard disk drives, solid-state drives, or other data storage device. Each data storage device 222 may include a system partition that stores data and firmware code for the data storage device 222 and one or more operating system partitions that store data files and executables for operating systems.

Each display device 224 may be embodied as any device or circuitry (e.g., a liquid crystal display (LCD), a light emitting diode (LED) display, a cathode ray tube (CRT) display, etc.) configured to display visual information (e.g., text, graphics, etc.) to a user. In some embodiments, a display device 224 may be embodied as a touch screen (e.g., a screen incorporating resistive touchscreen sensors, capacitive touchscreen sensors, surface acoustic wave (SAW) touchscreen sensors, infrared touchscreen sensors, optical imaging touchscreen sensors, acoustic touchscreen sensors, and/or other type of touchscreen sensors) to detect selections of on-screen user interface elements or gestures from a user.

In the illustrative embodiment, the components of the simulation compute device 120 are housed in a single unit. However, in other embodiments, the components may be in separate housings, in separate racks of a data center, and/or spread across multiple data centers or other facilities. The compute devices 110, 122, 140, 162, 164, 170, 172, 180, 182 may have components similar to those described in FIG. 2 with reference to the simulation compute device 120. The description of those components of the simulation compute device 120 is equally applicable to the description of components of the compute devices 110, 122, 140, 162, 164, 170, 172, 180, 182. Further, it should be appreciated that any of the devices 110, 120, 122, 140, 162, 164, 170, 172, 180, 182 may include other components, sub-components, and devices commonly found in a computing device, which are not discussed above in reference to the simulation compute device 120 and not discussed herein for clarity of the description.

In the illustrative embodiment, the compute devices 110, 120, 122, 140, 162, 164, 170, 172, 180, 182, are in communication via a network 190, which may be embodied as any type of wired or wireless communication network, including global networks (e.g., the internet), wide area networks (WANs), local area networks (LANs), digital subscriber line (DSL) networks, cable networks (e.g., coaxial networks, fiber networks, etc.), cellular networks (e.g., Global System for Mobile Communications (GSM), Long Term Evolution (LTE), Worldwide Interoperability for Microwave Access (WiMAX), 3G, 4G, 5G, etc.), a radio area network (RAN), or any combination thereof.

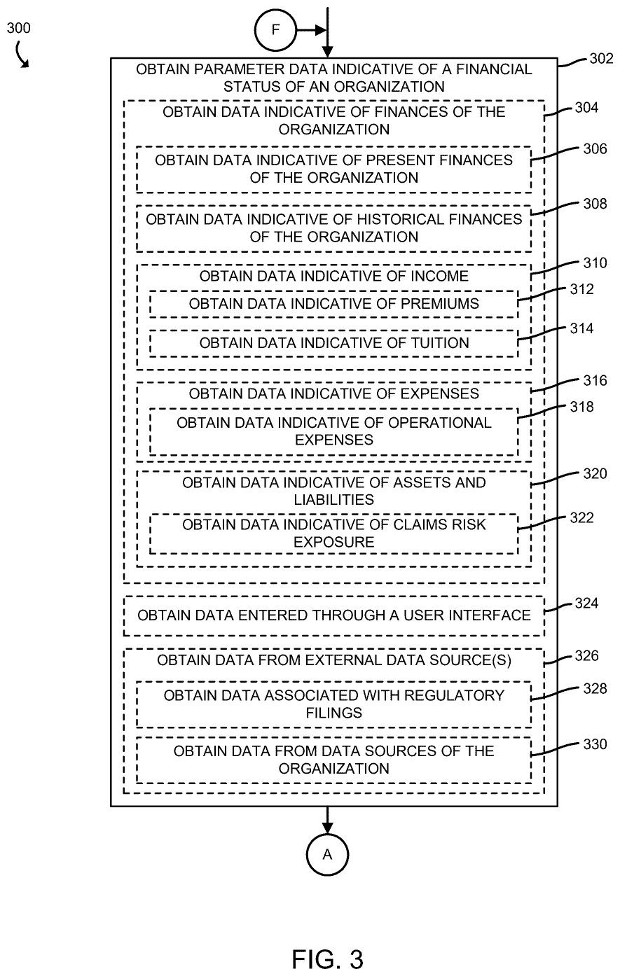

Referring now to FIG. 3, the simulation system 110 may perform a method 300 for performing enterprise financial modeling (e.g., simulating the effects of potential investments on the financial health of an organization). The method 300, in the illustrative embodiment, begins with block 302 in which the simulation system 110 obtains parameter data indicative of a financial status of an organization (e.g., an enterprise). In doing so, in the illustrative embodiment, the simulation system 110 obtains data indicative of finances of the organization, as indicated in block 304. The simulation system 110, in doing so, may obtain data indicative of the present finances (e.g., current finances) of the organization, as indicated in block 306 and may obtain data indicative of historical finances of the organization, as indicated in block 308. The simulation system 110 may obtain data indicative of income, as indicated in block 310. For example, for an insurance organization, the simulation system 110 may obtain data indicative of premiums (e.g., paid by policy holders) received by the organization, as indicated in block 312. As another example, if the organization is a higher education organization (e.g., a university) the simulation system 110 may obtain data indicative of tuition (e.g., paid by students) received by the organization, as indicated in block 314.

Still referring to FIG. 3, the simulation system 110 may obtain data indicative of expenses of the organization, as indicated in block 316. For example, the simulation system 110 may obtain data indicative of operational expenses (e.g., salaries of staff, maintenance costs for one or more buildings, equipment costs, and the like), as indicated in block 318. Further, for an insurance organization, the expenses may include payouts on insurance claims. For a higher education organization, the expenses may include student relief expenditures and/or other expenses related to the operation of a higher education institution. Additionally, the simulation system 110 may obtain data indicative of assets and liabilities of the organization, as indicated in block 320. For example, for an insurance organization, the simulation system 110 may obtain data indicative of claims risk exposure, as indicated in block 322. In obtaining the parameter data, the simulation system 110 may obtain data entered through a user interface (e.g., a web-based interface, a user interface in a mobile application, etc.) executed by a user compute device 180, 182 communicatively coupled to the simulation system 110 (e.g., via the network 190), as indicated in block 324. The simulation system 110 may additionally or alternatively obtain data from one or more external data sources (e.g., one or more source compute devices 170, 172), as indicated in block 326. For example, and as indicated in block 328, the simulation system 110 may obtain data associated with one or more regulatory filings (e.g., 10-K and/or 10-Q forms filed with the Securities and Exchange Commission (SEC)). The simulation system 110 may additionally or alternatively obtain data, such as one or more files indicative of income statements or other records indicative of the finances of the organization, from one or more data sources (e.g., one or more of the source compute devices 170, 172) of the organization itself, as indicated in block 330.

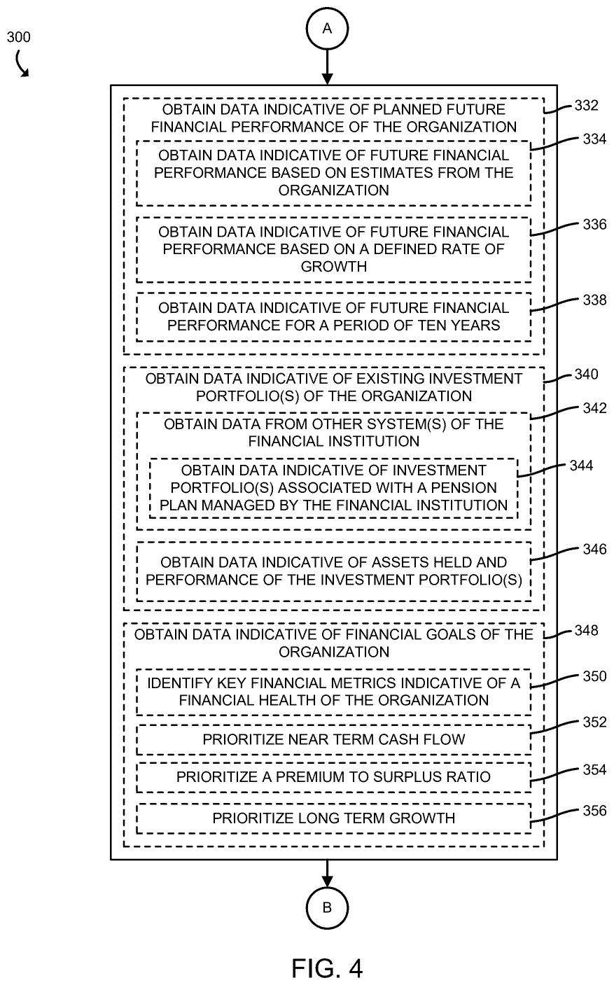

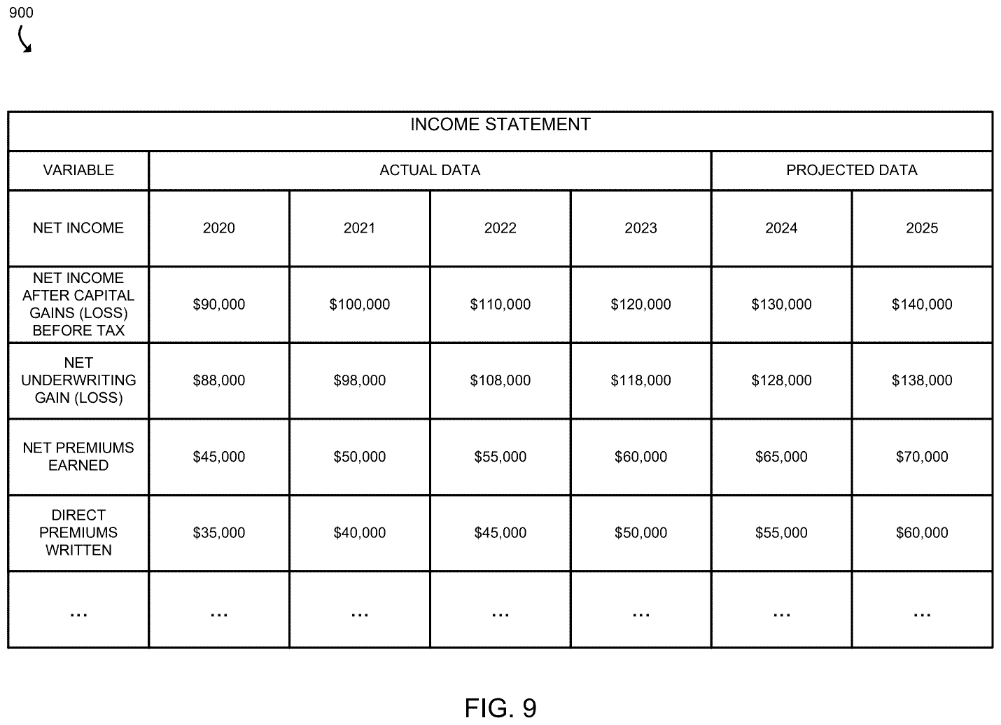

Referring now to FIG. 4, the simulation system 110 may obtain data indicative of planned future financial performance of the organization, as indicated in block 332. In doing so, the simulation system 110 may obtain data indicative of a future financial performance of the organization based on estimates provided by personnel of the organization, as indicated in block 334. Additionally or alternatively, the simulation system 110 may obtain data indicative of future financial performance based on a defined rate of growth (e.g., a rate of growth exhibited from the historical finances and present finances) of the organization's finances (e.g., by multiplying the present finances by the defined rate of growth for each year of a defined time period), as indicated in block 336. An embodiment of an income statement 900 with historical, present, and planned future financial data for an organization that may be utilized by the simulation system 110 (e.g., in obtaining the parameter data) is shown in FIG. 9. The simulation system 110, in the illustrative embodiment, obtains data indicative of future financial performance of the organization for a period a defined period of time (e.g., ten years), as indicated in block 338. In obtaining parameter data, the simulation system 110 may obtain data indicative of one or more existing investment portfolios (e.g., mixes of investment assets) of the organization, as indicated in block 340. As indicated in block 342, the simulation system 110 may obtain the data from another system of the financial institution (e.g., from the financial institution systems 160). In doing so, the simulation system 110 may obtain data indicative of one or more investment portfolios associated with a pension plan managed by the financial institution on behalf of the organization, as indicated in block 344. In obtaining the data, the simulation system 110, in the illustrative embodiment, obtains data indicative of the assets held (e.g., in the portfolio(s)) and the performance of the portfolio(s) (e.g., growth and/or income produced over a defined time period), as indicated in block 346.

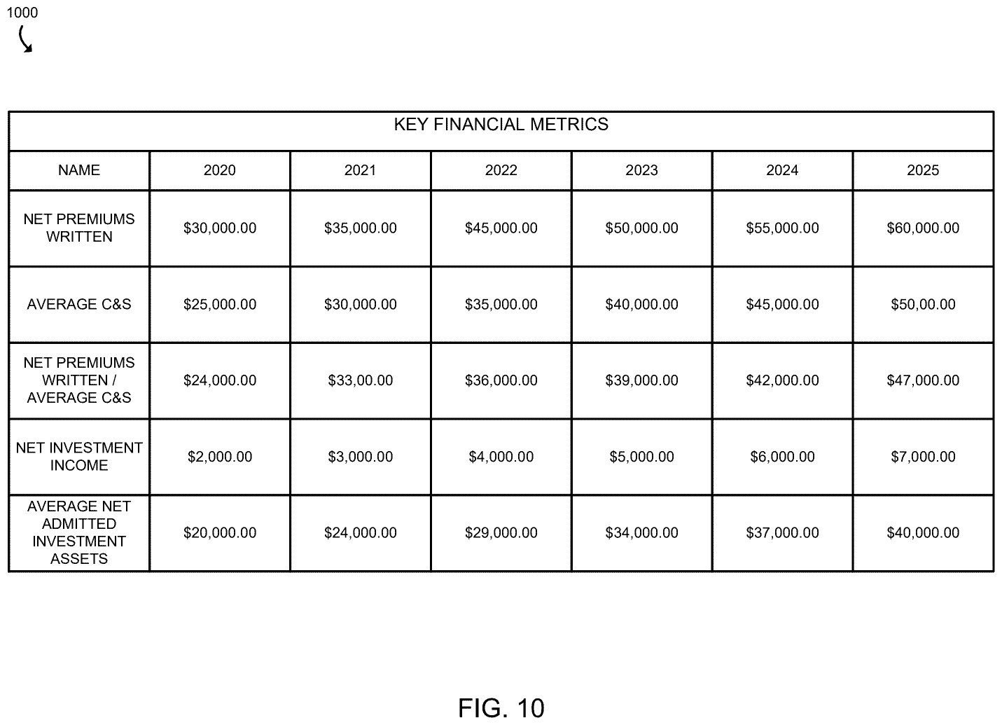

Still referring to FIG. 4, the simulation system 110, in the illustrative embodiment, obtains data indicative of one or more financial goals of the organization, as indicated in block 348. In doing so, the simulation system 110 may identify one or more key (e.g., significant) financial metrics indicative of a financial health of the organization, as indicated in block 350. An embodiment of a set of key financial metrics 1000 for an organization (e.g., an insurance organization) that may be utilized by the simulation system 110 is shown in FIG. 10. In the illustrative embodiment, the one or more key financial metrics are indicative of an ability of the organization to continue and grow its business. As discussed above, for different types of organizations, the key financial metrics may differ. For example, an insurance organization may be more concerned with maintaining or increasing a premium to surplus ratio (e.g., to enable additional insurance policies) while another type of organization may be more concerned with near term cash flow (e.g., to finance day to day operations). Accordingly, and as indicated in block 352, the simulation system 110 may obtain data indicative of a financial goal (e.g., of the organization) to prioritize near term cash flow. Additionally or alternatively, the simulation system 110 may obtain data indicative of a financial goal to prioritize a premium to surplus ratio, as indicated in block 354 and/or may obtain data indicative of a financial goal to prioritize long term growth, as indicated in block 356.

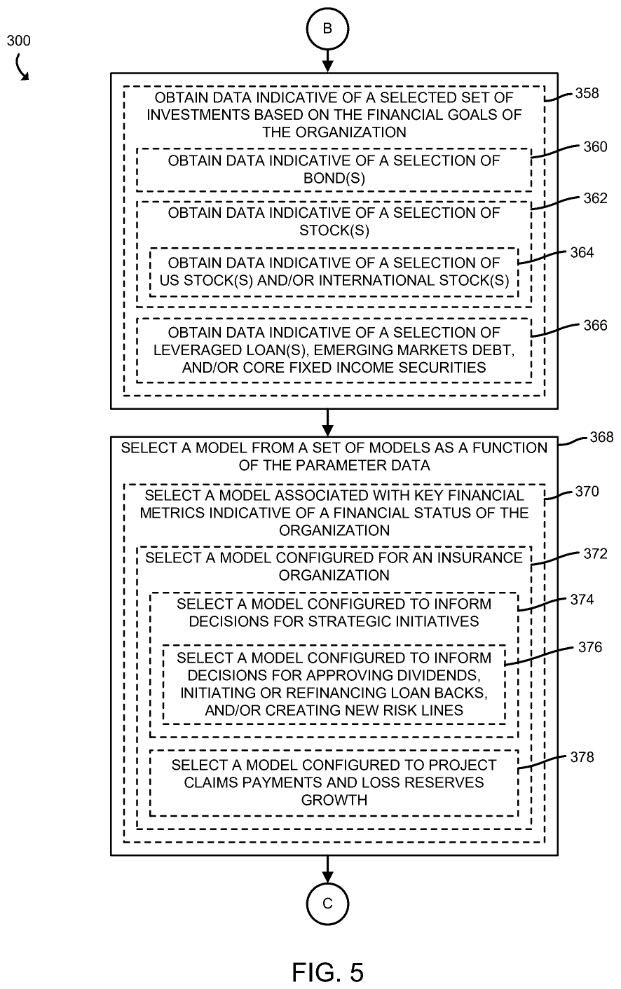

In the illustrative embodiment, the method 300 continues in FIG. 5. As shown in FIG. 5, the simulation system 110, in the illustrative embodiment, obtains data indicative of a selected set of investments based on the financial goal(s) of the organization (e.g., from block 348), as indicated in block 358. In doing so, and as indicated in block 360, the simulation system 110 may obtain data indicative of a selection of one or more bonds. Additionally or alternatively, the simulation system 110 may obtain data indicative of a selection of one or more stocks, as indicated in block 362. In doing so, the simulation system 110 may obtain data indicative of a selection of US stocks and/or international stocks, as indicated in block 364. In some embodiments, the simulation system 110 may obtain data indicative of a selection of leveraged loan(s), emerging markets debt, and/or core fixed income securities, as indicated in block 366. The investments may be identified by a person associated with the financial institution and approved by the organization and/or, in some embodiments, may be selected by the simulation system 110 (e.g., based on a lookup table or other data structure in memory 214 or data storage 222 that associates types of investment assets with corresponding financial goals).

In the illustrative embodiment, the method 300 continues in block 368, in which the simulation system 110 selects a model from a set of models (e.g., from the models 142, 144 of the model library server 140) as a function of the parameter data (e.g., obtained in block 302). In doing so, and as indicated in block 370, the simulation system 110 selects a model 142, 144 associated with the key financial metrics, indicative of the financial status of the organization. That is, the model 142, 144, in the illustrative embodiment, includes algorithms, structures, weights, or the like to track the key financial metrics and determine (e.g., with varying degrees of confidence or probability) the effect(s) of the selected investments on those key financial metrics. The simulation system 110 may select the corresponding model by comparing the key financial metrics identified in block 350 with a lookup table or other data structure that associates models with sets of key financial metrics. The simulation system 110 may select a model configured for an insurance organization, as indicated in block 372. In doing so, the simulation system 110 may select a model configured to inform decisions for strategic initiatives of the organization, as indicated in block 374. For example, and as indicated in block 374, the simulation system may select a model configured to inform decisions for approving dividends, initiating or refinancing loan backs, and/or creating new risk lines, as indicated in block 376. As indicated in block 378, the simulation system 110 may select a model configured to project claims payment and loss reserves growth.

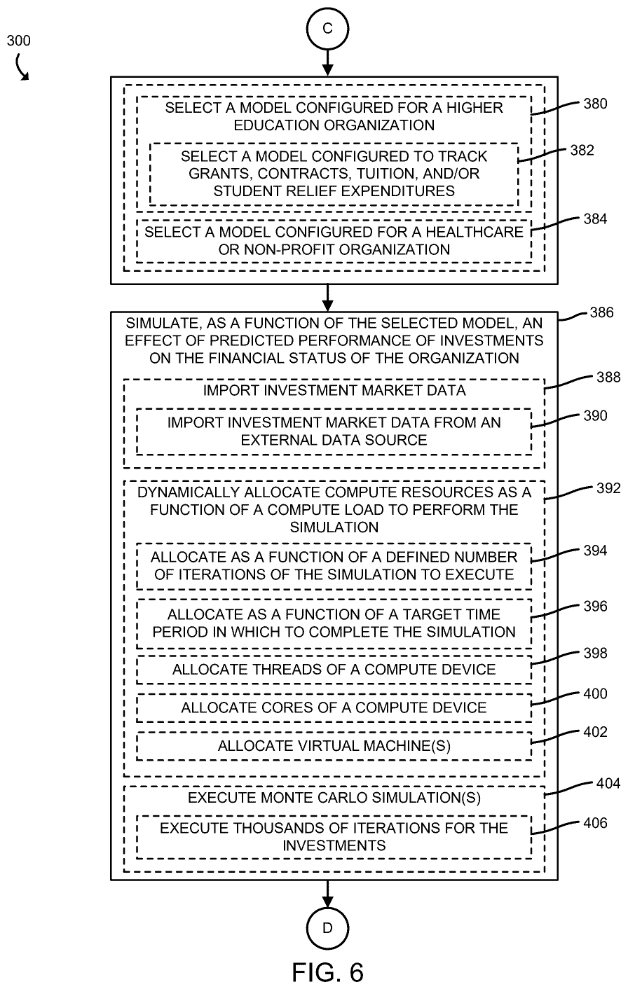

Continuing the method 300, in FIG. 6, in some embodiments (e.g., if the organization is a higher education organization), the simulation system 110 may select a model configured for a higher education organization, as indicated in block 380. In doing so, and as indicated in block 382, the simulation system 110 may select a model configured to track grants, contracts, tuition and/or student relief expenditures of a higher education organization. In other embodiments, the simulation system 110 may select a model for another type of organization, such as a healthcare organization or a non-profit organization, as indicated in block 384. Subsequently, and as indicated in block 386, the simulation system 110 simulates, as a function of the selected model 142, 144 (e.g., utilizing the algorithm(s), data structures, weights, etc. defined by the model 142, 144), an effect of predicted performance of the investments (e.g., the selected investments from block 358) on the financial status (e.g., financial health) of the organization. In doing so, the simulation system 110 may import investment market data, which may be embodied as any data indicative of the performance of investment assets over a period of time, as indicated in block 388. As indicated in block 390, the simulation system 110 may import the investment market data from an external data source, such as a source compute device 170, 172, which may be operated by a third party supplier of market data. In simulating the effect of the predicted performance of the investments on the financial status of the organization, the simulation system 110 (e.g., the orchestrator device 150) may dynamically allocate compute resources (e.g., the compute resources 130, 132, 134, 136) as a function of a compute load (e.g., number of operations to be performed, a rate at which the operations should be performed (operations per second), etc.), to perform the simulation, as indicated in block 392.

In allocating compute resources 130, 132, 134, 136 as a function of a compute load, the simulation system 110 may allocate compute resources 130, 132, 134, 136 as a function of a defined number (e.g., a user defined number, a hard coded number, a number in a configuration setting in memory 214, etc.) of iterations of the simulation to execute, as indicated in block 394.

For example, if the number of iterations is five thousand, the simulation system 110 may allocate more compute resources 130, 132, 134, 136 than if the number of iterations is one thousand. As indicated in block 396, the simulation system 110 may allocate the compute resources 130, 132, 134, 136 as a function of a target time period in which to complete the simulation. That is, simulation system 110 may multiply a defined number of operations required to complete an iteration by the number of iterations to be executed, then divide that product by a number of seconds in which the simulation is to be completed, to obtain a rate (e.g., operations per second) at which the simulation is to be performed. Further, the simulation system 110 may divide the rate by the operations per second that each compute resource 130, 132, 134, 136 is capable of performing to obtain the total number of compute resources 130, 132, 134, 136 to allocate. In allocating compute resources, the simulation system 110 may allocate threads of one or more compute devices 120, 122, cores of one or more compute devices 120, 122, and/or virtual machines (e.g., composed of virtualized hardware of the compute devices 120, 122), as indicated in blocks 398, 400, and 402 respectively. In executing the simulation, the simulation system 110 may execute one or more Monte Carlo simulations (e.g., defining a domain of inputs, generating inputs randomly from a probability distribution over the domain, performing a deterministic computation of the outputs, and aggregating the results), as indicated in block 404. In the illustrative embodiment, the simulation system 110 may execute thousands of iterations (e.g., based on thousands of sets of inputs from the probability distribution) to determine potential outcomes for the set of investments (e.g., from block 358), as indicated in block 406.

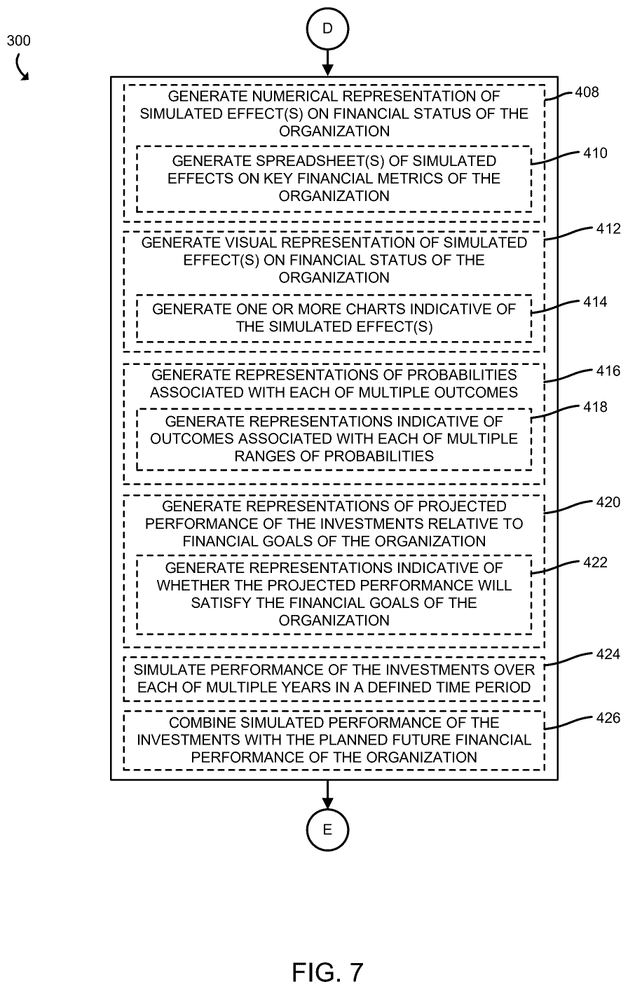

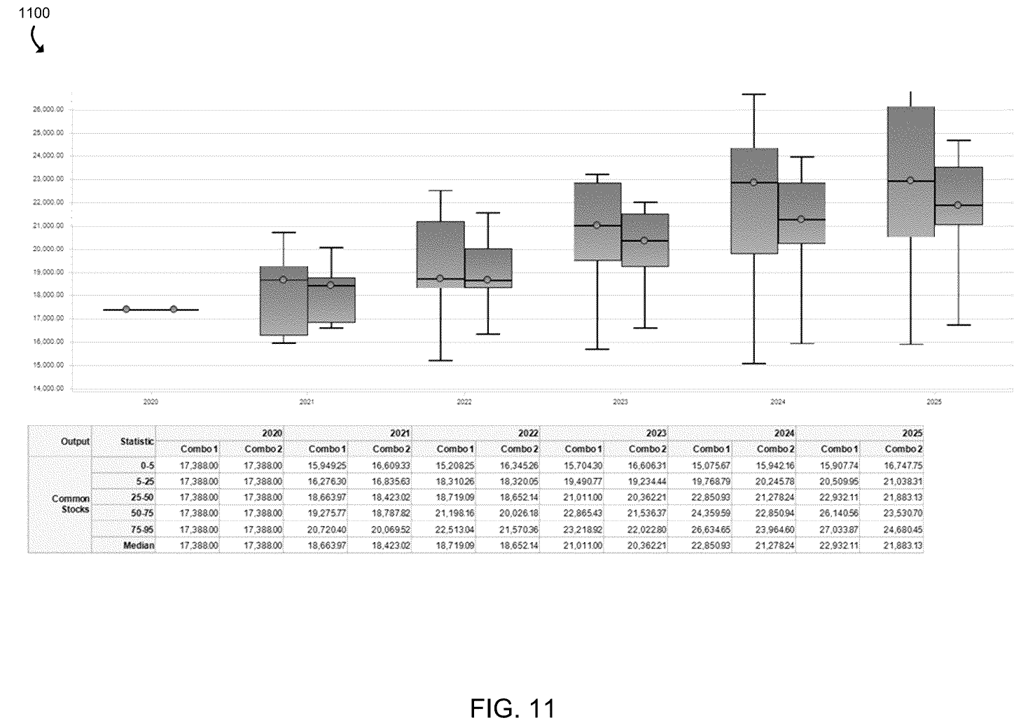

Referring now to FIG. 7, in performing the simulation, the simulation system 110 may generate a numerical representation of one or more simulated effects on the financial status of the organization (e.g., resulting from possible outcomes for the investments), as indicated in block 408. For example, and as indicated in block 410, the simulation system 110 may generate one or more spreadsheets of simulated effects on the key financial metrics (e.g., from block 350) of the organization. The simulation system 110 may, in some embodiments, generate a visual representation of one or more simulated effects on the financial status of the organization, as indicated in block 412. In doing so, and as indicated in block 414, the simulation system 110 may generate one or more charts (e.g., plots, graphs, etc.) indicative of the one or more simulated effects. The simulation system 110, in the illustrative embodiment, generates representations of probabilities associated with each of multiple outcomes (e.g., based on a probability distribution from the Monte Carlo simulation), as indicated in block 416. In doing so, the simulation system 110 may generate representations indicative of outcomes associated with each of multiple ranges of probabilities, as indicated in block 418. For example, the simulation system 110 may generate representations for outcomes with probabilities in the ranges of 0%-5%, 5%-25%, 25%-50%, 50%-75%, 75%-95%, and so on. An embodiment of a user interface 1100 that may be produced by the simulation system 110 indicating probabilities associated with multiple possible outcomes for a set of investments is shown in FIG. 11. The simulation system 110 may generate representations of the projected performance of the investments relative to the financial goals of the organization, as indicated in block 420. That is, in some embodiments, the simulation system 110 may generate one or more representations indicative of whether the projected performance will satisfy (e.g., enable achievement of) the financial goals of the organization, as indicated in block 422. The simulation system 110 may simulate performance of the investments over each of multiple years in a defined time period (e.g., each year in a ten year time period), as indicated in block 424. In some embodiments, the simulation system 110 may combine the simulated performance of the investments with the planned future financial performance of the organization (e.g., the planned future financial performance from block 332), as indicated in block 426. For example, the simulation system 110 may add the projected growth of the investments to the planned future financial performance to obtain combined values.

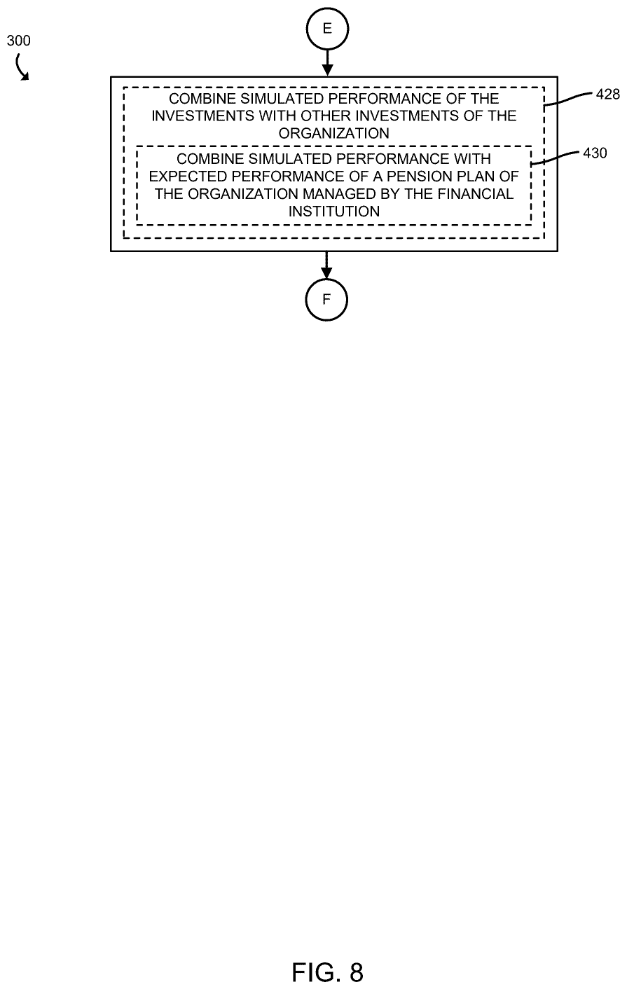

Referring now to FIG. 8, continuing the method 300 in block 428, the simulation system 110 may combine simulated performance of the investments (e.g., from the Monte Carlo simulations) with the performance of other investments associated with the organization (e.g., investments outside of those selected in block 358). In doing so, and as indicated in block 430, the simulation system 110 may combine the simulated performance of the investments with expected performance of a pension plan of the organization, as indicated in block 430. The pension plan may be managed by the financial institution operating the simulation system 110 and, accordingly, the simulation system 110 may obtain data relating to the investments associated with the pension plan from systems of the financial institution (e.g., the financial institution systems 160 shown in FIG. 1). As indicated, the method 300 may loop back to block 302 in which one or more of the operations may be repeated (e.g., selection of different investments, adjustment of financial goals) based on the simulation results produced by the simulation system 110. For example, if the simulation indicates that the a selected set of investments is unlikely (e.g., below a reference probability threshold) to satisfy a financial goal of a target amount of cash flow, the method 300 may loop back to obtain a different selection of investments with a higher emphasis on short term income and reduced emphasis on long term growth. Unlike conventional systems and due to the efficiency with which the simulation operations can be assigned across compute resources 130, 132, 134, 136 (e.g., by the orchestrator device 150), as described above, the simulation system 110 enables the compute devices 120, 122 to rapidly evaluate the outcomes of varying mixtures of investments for differing financial goals. Further, due to the dynamic allocation of compute resources 130, 132, 134, 136, the simulation system 110 may perform separate instances of the method 300 contemporaneously for different organizations with different financial goals without overburdening the available compute resources 130, 132, 134, 136.

While certain illustrative embodiments have been described in detail in the drawings and the foregoing description, such an illustration and description is to be considered as exemplary and not restrictive in character, it being understood that only illustrative embodiments have been shown and described and that all changes and modifications that come within the spirit of the disclosure are desired to be protected. There exist a plurality of advantages of the present disclosure arising from the various features of the apparatus, systems, and methods described herein. It will be noted that alternative embodiments of the apparatus, systems, and methods of the present disclosure may not include all of the features described, yet still benefit from at least some of the advantages of such features. Those of ordinary skill in the art may readily devise their own implementations of the apparatus, systems, and methods that incorporate one or more of the features of the present disclosure.

### EXAMPLES

Illustrative examples of the technologies disclosed herein are provided below. An embodiment of the technologies may include any one or more, and any combination of, the examples described below.

Example 1 includes a system comprising circuitry configured to obtain parameter data indicative of a financial status of an organization; select, as a function of the parameter data and from a set of models for tracking key financial metrics of different types of organizations, a model; and simulate, using the selected model and by dynamically allocating compute resources across multiple compute devices as a function of a simulation compute load, an effect of a predicted performance of a set of investments on the financial status of the organization.

Example 2 includes the subject matter of Example 1, and wherein to obtain data indicative of a financial status of an organization comprises to obtain data indicative of present finances of the organization and historical finances of the organization.

Example 3 includes the subject matter of any of Examples 1 and 2, and wherein to obtain data indicative of a financial status of an organization comprises to obtain data indicative of income.

Example 4 includes the subject matter of any of Examples 1-3, and wherein to obtain data indicative of income comprises to obtain data indicative of premiums or tuition.

Example 5 includes the subject matter of any of Examples 1-4, and wherein to obtain data indicative of a financial status of an organization comprises to obtain data indicative of expenses.

Example 6 includes the subject matter of any of Examples 1-5, and wherein to obtain data indicative of a financial status of an organization comprises to obtain data indicative of assets and liabilities.

Example 7 includes the subject matter of any of Examples 1-6, and wherein to obtain data indicative of a financial status of an organization comprises to obtain data indicative of claims risk exposure.

Example 8 includes the subject matter of any of Examples 1-7, and wherein to obtain data indicative of a financial status of an organization comprises to obtain data entered through a user interface.

Example 9 includes the subject matter of any of Examples 1-8, and wherein to obtain data indicative of a financial status of an organization comprises to obtain data from one or more external data sources.

Example 10 includes the subject matter of any of Examples 1-9, and wherein to obtain data from one or more external data sources comprises to obtain data associated with one or more regulatory filings of the organization or from one or more data sources of the organization.

Example 11 includes the subject matter of any of Examples 1-10, and wherein to obtain data indicative of a financial status of an organization comprises to obtain data indicative of planned future financial performance of the organization.

Example 12 includes the subject matter of any of Examples 1-11, and wherein to obtain data indicative of a planned future financial performance of the organization comprises to obtain data indicative of future financial performance based on one or more of estimates from the organization or a defined rate of growth.

Example 13 includes the subject matter of any of Examples 1-12, and wherein to obtain data indicative of a planned future financial performance of the organization comprises to obtain data indicative of future financial performance for a period of ten years.

Example 14 includes the subject matter of any of Examples 1-13, and wherein to obtain data indicative of a financial status of an organization comprises to obtain data indicative of one or more existing investment portfolios of the organization.

Example 15 includes the subject matter of any of Examples 1-14, and wherein the system is a system of a financial institution, and to obtain data indicative of one or more existing investment portfolios of the organization comprises to obtain data from one or more other systems of the financial institution.

Example 16 includes the subject matter of any of Examples 1-15, and wherein to obtain data from one or more other systems of the financial institution comprises to obtain data indicative of one or more investment portfolios associated with a pension plan managed by the financial institution.

Example 17 includes the subject matter of any of Examples 1-16, and wherein to obtain data indicative of one or more existing investment portfolios of the organization comprises to obtain data indicative of assets held in the one or more investment portfolios and a performance of the one or more investment portfolios.

Example 18 includes the subject matter of any of Examples 1-17, and wherein to obtain data indicative of a financial status of an organization comprises to obtain data indicative of financial goals of the organization.

Example 19 includes the subject matter of any of Examples 1-18, and wherein to obtain data indicative of financial goals of the organization comprises to identify the key financial metrics of the organization.

Example 20 includes the subject matter of any of Examples 1-19, and wherein to obtain data indicative of financial goals of the organization comprises to prioritize near term cash flow, a premium to surplus ratio, or long term growth.

Example 21 includes the subject matter of any of Examples 1-20, and wherein the circuitry is further configured to obtain data indicative of a selected set of investments based on financial goals of the organization.

Example 22 includes the subject matter of any of Examples 1-21, and wherein to obtain data indicative of a selected set of investments comprises to obtain data indicative of a selection of one or more bonds, stocks, leveraged loans, emerging markets debt, or core fixed income securities.

Example 23 includes the subject matter of any of Examples 1-22, and wherein to select, as a function of the parameter data and from a set of models for tracking key financial metrics of different types of organizations, a model comprises to select a model configured for an insurance organization.

Example 24 includes the subject matter of any of Examples 1-23, and wherein to select a model configured for an insurance organization comprises to select a model configured to one or more of inform decisions for strategic initiatives or project claims payments and loss reserves growth.

Example 25 includes the subject matter of any of Examples 1-24, and wherein to select a model configured to inform decisions for strategic initiatives comprises to select a model configured to inform decisions for approving dividends, initiating or refinancing loan backs, or creating new risk lines.

Example 26 includes the subject matter of any of Examples 1-25, and wherein to select, as a function of the parameter data and from a set of models for tracking key financial metrics of different types of organizations, a model comprises to select a model configured for a higher education organization.

Example 27 includes the subject matter of any of Examples 1-26, and wherein to select a model configured for a higher education organization comprises to select a model configured to track one or more of grants, contracts, tuition, or student relief expenditures.

Example 28 includes the subject matter of any of Examples 1-27, and wherein to select, as a function of the parameter data and from a set of models for tracking key financial metrics of different types of organizations, a model comprises to select a model configured for a healthcare organization or a non-profit organization.

Example 29 includes the subject matter of any of Examples 1-28, and wherein to simulate an effect of a predicted performance of a set of investments on the financial status of the organization comprises to import investment market data from an external data source.

Example 30 includes the subject matter of any of Examples 1-29, and wherein to simulate an effect of a predicted performance of a set of investments on the financial status of the organization comprises to allocate compute resources as a function of a defined number of iterations of the simulation to execute.

Example 31 includes the subject matter of any of Examples 1-30, and wherein to simulate an effect of a predicted performance of a set of investments on the financial status of the organization comprises to allocate compute resources further as a function of a target time period in which to complete the simulation.

Example 32 includes the subject matter of any of Examples 1-31, and wherein to allocate compute resources comprises to allocate threads, cores, or virtual machines.

Example 33 includes the subject matter of any of Examples 1-32, and wherein to simulate an effect comprises to execute at least one Monte Carlo simulation.

Example 34 includes the subject matter of any of Examples 1-33, and wherein the circuitry is configured to execute thousands of iterations of a Monte Carlo simulation for the investments.

Example 35 includes the subject matter of any of Examples 1-34, and wherein to simulate an effect comprises to generate numerical representation of the simulated effect on the financial status of the organization.

Example 36 includes the subject matter of any of Examples 1-35, and wherein to generate a numerical representation comprises to generate a spreadsheet of the simulated effect on the key financial metrics of the organization.

Example 37 includes the subject matter of any of Examples 1-36, and wherein to simulate an effect comprises to generate a visual representation of the simulated effect.

Example 38 includes the subject matter of any of Examples 1-37, and wherein to generate a visual representation comprises to generate one or more charts indicative of the simulated effect.

Example 39 includes the subject matter of any of Examples 1-38, and wherein to simulate an effect comprises to generate a representation of probabilities associated with each of multiple possible outcomes.

Example 40 includes the subject matter of any of Examples 1-39, and wherein to generate a representation of probabilities comprises to generate a representation indicative of outcomes associated with each of multiple ranges of probabilities.

Example 41 includes the subject matter of any of Examples 1-40, and wherein to simulate an effect comprises to generate a representation of a projected performance of the investments relative to financial goals of the organization.

Example 42 includes the subject matter of any of Examples 1-41, and wherein the circuitry is configured to generate a representation indicative of whether the projected performance will satisfy the financial goals of the organization.

Example 43 includes the subject matter of any of Examples 1-42, and wherein to simulate an effect comprises to simulate performance of the investments over each of multiple years in a defined time period.

Example 44 includes the subject matter of any of Examples 1-43, and wherein to simulate an effect comprises to combine the simulated performance of the investments with a planned future financial performance of the organization.

Example 45 includes the subject matter of any of Examples 1-44, and wherein to simulate an effect comprises to combine a simulated performance of the investments with other investments of the organization.

Example 46 includes the subject matter of any of Examples 1-45, and wherein the system is associated with a financial institution, and wherein to combine a simulated performance of the investments with other investments of the organization comprises to combine the simulated performance with expected performance of a pension plan of the organization managed by the financial institution.

Example 47 includes a method comprising obtaining, by a simulation system, parameter data indicative of a financial status of an organization; selecting, by the simulation system and as a function of the parameter data and from a set of models for tracking key financial metrics of different types of organizations, a model; and simulating, by the simulation system and using the selected model and by dynamically allocating compute resources across multiple compute devices as a function of a simulation compute load, an effect of a predicted performance of a set of investments on the financial status of the organization.

Example 48 includes the subject matter of Example 47, and wherein obtaining data indicative of a financial status of an organization comprises obtaining data indicative of present finances of the organization and historical finances of the organization.

Example 49 includes the subject matter of any of Examples 47 and 48, and wherein obtaining data indicative of a financial status of an organization comprises obtaining data indicative of income.

Example 50 includes the subject matter of any of Examples 47-49, and wherein obtaining data indicative of income comprises obtaining data indicative of premiums or tuition.

Example 51 includes the subject matter of any of Examples 47-50, and wherein obtaining data indicative of a financial status of an organization comprises obtaining data indicative of expenses.

Example 52 includes the subject matter of any of Examples 47-51, and wherein obtaining data indicative of a financial status of an organization comprises obtaining data indicative of assets and liabilities.

Example 53 includes the subject matter of any of Examples 47-52, and wherein obtaining data indicative of a financial status of an organization comprises obtaining data indicative of claims risk exposure.

Example 54 includes the subject matter of any of Examples 47-53, and wherein obtaining data indicative of a financial status of an organization comprises obtaining data entered through a user interface.

Example 55 includes the subject matter of any of Examples 47-54, and wherein obtaining data indicative of a financial status of an organization comprises obtaining data from one or more external data sources.

Example 56 includes the subject matter of any of Examples 47-55, and wherein obtaining data from one or more external data sources comprises obtaining data associated with one or more regulatory filings of the organization or from one or more data sources of the organization.

Example 57 includes the subject matter of any of Examples 47-56, and wherein obtaining data indicative of a financial status of an organization comprises obtaining data indicative of planned future financial performance of the organization.

Example 58 includes the subject matter of any of Examples 47-57, and wherein obtaining data indicative of a planned future financial performance of the organization comprises obtaining data indicative of future financial performance based on one or more of estimates from the organization or a defined rate of growth.

Example 59 includes the subject matter of any of Examples 47-58, and wherein obtaining data indicative of a planned future financial performance of the organization comprises obtaining data indicative of future financial performance for a period of ten years.

Example 60 includes the subject matter of any of Examples 47-59, and wherein obtaining data indicative of a financial status of an organization comprises obtaining data indicative of one or more existing investment portfolios of the organization.

Example 61 includes the subject matter of any of Examples 47-60, and wherein the simulation system is associated with a financial institution, and obtaining data indicative of one or more existing investment portfolios of the organization comprises obtaining data from one or more other systems of the financial institution.

Example 62 includes the subject matter of any of Examples 47-61, and wherein obtaining data from one or more other systems of the financial institution comprises obtaining data indicative of one or more investment portfolios associated with a pension plan managed by the financial institution.

Example 63 includes the subject matter of any of Examples 47-62, and wherein obtaining data indicative of one or more existing investment portfolios of the organization comprises obtaining data indicative of assets held in the one or more investment portfolios and a performance of the one or more investment portfolios.

Example 64 includes the subject matter of any of Examples 47-63, and wherein obtaining data indicative of a financial status of an organization comprises obtaining data indicative of financial goals of the organization.

Example 65 includes the subject matter of any of Examples 47-64, and wherein obtaining data indicative of financial goals of the organization comprises identifying the key financial metrics of the organization.

Example 66 includes the subject matter of any of Examples 47-65, and wherein obtaining data indicative of financial goals of the organization comprises prioritizing near term cash flow, a premium to surplus ratio, or long term growth.

Example 67 includes the subject matter of any of Examples 47-66, and further including obtaining, by the simulation system, data indicative of a selected set of investments based on financial goals of the organization.

Example 68 includes the subject matter of any of Examples 47-67, and wherein obtaining data indicative of a selected set of investments comprises obtaining data indicative of a selection of one or more bonds, stocks, leveraged loans, emerging markets debt, or core fixed income securities.

Example 69 includes the subject matter of any of Examples 47-68, and wherein selecting, as a function of the parameter data and from a set of models for tracking key financial metrics of different types of organizations, a model comprises selecting a model configured for an insurance organization.

Example 70 includes the subject matter of any of Examples 47-69, and wherein selecting a model configured for an insurance organization comprises selecting a model configured to one or more of inform decisions for strategic initiatives or project claims payments and loss reserves growth.

Example 71 includes the subject matter of any of Examples 47-70, and wherein selecting a model configured to inform decisions for strategic initiatives comprises selecting a model configured to inform decisions for approving dividends, initiating or refinancing loan backs, or creating new risk lines.

Example 72 includes the subject matter of any of Examples 47-71, and wherein selecting, as a function of the parameter data and from a set of models for tracking key financial metrics of different types of organizations, a model comprises selecting a model configured for a higher education organization.

Example 73 includes the subject matter of any of Examples 47-72, and wherein selecting a model configured for a higher education organization comprises selecting a model configured to track one or more of grants, contracts, tuition, or student relief expenditures.

Example 74 includes the subject matter of any of Examples 47-73, and wherein selecting, as a function of the parameter data and from a set of models for tracking key financial metrics of different types of organizations, a model comprises selecting a model configured for a healthcare organization or a non-profit organization.

Example 75 includes the subject matter of any of Examples 47-74, and wherein simulating an effect of a predicted performance of a set of investments on the financial status of the organization comprises importing investment market data from an external data source.

Example 76 includes the subject matter of any of Examples 47-75, and wherein simulating an effect of a predicted performance of a set of investments on the financial status of the organization comprises allocating compute resources as a function of a defined number of iterations of the simulation to execute.

Example 77 includes the subject matter of any of Examples 47-76, and wherein simulating an effect of a predicted performance of a set of investments on the financial status of the organization comprises allocating compute resources further as a function of a target time period in which to complete the simulation.

Example 78 includes the subject matter of any of Examples 47-77, and wherein allocating compute resources comprises allocating threads, cores, or virtual machines.

Example 79 includes the subject matter of any of Examples 47-78, and wherein simulating an effect comprises executing at least one Monte Carlo simulation.

Example 80 includes the subject matter of any of Examples 47-79, and further including executing thousands of iterations of a Monte Carlo simulation for the investments.

Example 81 includes the subject matter of any of Examples 47-80, and wherein simulating an effect comprises generating a numerical representation of the simulated effect on the financial status of the organization.

Example 82 includes the subject matter of any of Examples 47-81, and wherein generating a numerical representation comprises generating a spreadsheet of the simulated effect on the key financial metrics of the organization.

Example 83 includes the subject matter of any of Examples 47-82, and wherein simulating an effect comprises generating a visual representation of the simulated effect.

Example 84 includes the subject matter of any of Examples 47-83, and wherein generating a visual representation comprises generating one or more charts indicative of the simulated effect.

Example 85 includes the subject matter of any of Examples 47-84, and wherein simulating an effect comprises generating a representation of probabilities associated with each of multiple possible outcomes.

Example 86 includes the subject matter of any of Examples 47-85, and wherein generating a representation of probabilities comprises generating a representation indicative of outcomes associated with each of multiple ranges of probabilities.

Example 87 includes the subject matter of any of Examples 47-86, and wherein simulating an effect comprises generating a representation of a projected performance of the investments relative to financial goals of the organization.

Example 88 includes the subject matter of any of Examples 47-87, and further including generating a representation indicative of whether the projected performance will satisfy the financial goals of the organization.

Example 89 includes the subject matter of any of Examples 47-88, and wherein simulating an effect comprises to simulating performance of the investments over each of multiple years in a defined time period.

Example 90 includes the subject matter of any of Examples 47-89, and wherein simulating an effect comprises combining the simulated performance of the investments with a planned future financial performance of the organization.

Example 91 includes the subject matter of any of Examples 47-90, and wherein simulating an effect comprises combining a simulated performance of the investments with other investments of the organization.

Example 92 includes the subject matter of any of Examples 47-91, and wherein the simulation system is associated with a financial institution, and wherein combining a simulated performance of the investments with other investments of the organization comprises combining the simulated performance with expected performance of a pension plan of the organization managed by the financial institution.

Example 93 includes one or more machine-readable storage media comprising a plurality of instructions stored thereon that, in response to being executed, cause a simulation system to obtain parameter data indicative of a financial status of an organization; select, as a function of the parameter data and from a set of models for tracking key financial metrics of different types of organizations, a model; and simulate, using the selected model and by dynamically allocating compute resources across multiple compute devices as a function of a simulation compute load, an effect of a predicted performance of a set of investments on the financial status of the organization.

Example 94 includes the subject matter of Example 93, and wherein to obtain data indicative of a financial status of an organization comprises to obtain data indicative of present finances of the organization and historical finances of the organization.

Example 95 includes the subject matter of any of Examples 93 and 94, and wherein to obtain data indicative of a financial status of an organization comprises to obtain data indicative of income.

Example 96 includes the subject matter of any of Examples 93-95, and wherein to obtain data indicative of income comprises to obtain data indicative of premiums or tuition.

Example 97 includes the subject matter of any of Examples 93-96, and wherein to obtain data indicative of a financial status of an organization comprises to obtain data indicative of expenses.

Example 98 includes the subject matter of any of Examples 93-97, and wherein to obtain data indicative of a financial status of an organization comprises to obtain data indicative of assets and liabilities.

Example 99 includes the subject matter of any of Examples 93-98, and wherein to obtain data indicative of a financial status of an organization comprises to obtain data indicative of claims risk exposure.

Example 100 includes the subject matter of any of Examples 93-99, and wherein to obtain data indicative of a financial status of an organization comprises to obtain data entered through a user interface.

Example 101 includes the subject matter of any of Examples 93-100, and wherein to obtain data indicative of a financial status of an organization comprises to obtain data from one or more external data sources.

Example 102 includes the subject matter of any of Examples 93-101, and wherein to obtain data from one or more external data sources comprises to obtain data associated with one or more regulatory filings of the organization or from one or more data sources of the organization.

Example 103 includes the subject matter of any of Examples 93-102, and wherein to obtain data indicative of a financial status of an organization comprises to obtain data indicative of planned future financial performance of the organization.

Example 104 includes the subject matter of any of Examples 93-103, and wherein to obtain data indicative of a planned future financial performance of the organization comprises to obtain data indicative of future financial performance based on one or more of estimates from the organization or a defined rate of growth.

Example 105 includes the subject matter of any of Examples 93-104, and wherein to obtain data indicative of a planned future financial performance of the organization comprises to obtain data indicative of future financial performance for a period of ten years.

Example 106 includes the subject matter of any of Examples 93-105, and wherein to obtain data indicative of a financial status of an organization comprises to obtain data indicative of one or more existing investment portfolios of the organization.

Example 107 includes the subject matter of any of Examples 93-106, and wherein the simulation system is a system of a financial institution, and to obtain data indicative of one or more existing investment portfolios of the organization comprises to obtain data from one or more other systems of the financial institution.

Example 108 includes the subject matter of any of Examples 93-107, and wherein to obtain data from one or more other systems of the financial institution comprises to obtain data indicative of one or more investment portfolios associated with a pension plan managed by the financial institution.

Example 109 includes the subject matter of any of Examples 93-108, and wherein to obtain data indicative of one or more existing investment portfolios of the organization comprises to obtain data indicative of assets held in the one or more investment portfolios and a performance of the one or more investment portfolios.

Example 110 includes the subject matter of any of Examples 93-109, and wherein to obtain data indicative of a financial status of an organization comprises to obtain data indicative of financial goals of the organization.

Example 111 includes the subject matter of any of Examples 93-110, and wherein to obtain data indicative of financial goals of the organization comprises to identify the key financial metrics of the organization.

Example 112 includes the subject matter of any of Examples 93-111, and wherein to obtain data indicative of financial goals of the organization comprises to prioritize near term cash flow, a premium to surplus ratio, or long term growth.

Example 113 includes the subject matter of any of Examples 93-112, and wherein the instructions additionally cause the simulation system to obtain data indicative of a selected set of investments based on financial goals of the organization.

Example 114 includes the subject matter of any of Examples 93-113, and wherein to obtain data indicative of a selected set of investments comprises to obtain data indicative of a selection of one or more bonds, stocks, leveraged loans, emerging markets debt, or core fixed income securities.

Example 115 includes the subject matter of any of Examples 93-114, and wherein to select, as a function of the parameter data and from a set of models for tracking key financial metrics of different types of organizations, a model comprises to select a model configured for an insurance organization.

Example 116 includes the subject matter of any of Examples 93-115, and wherein to select a model configured for an insurance organization comprises to select a model configured to one or more of inform decisions for strategic initiatives or project claims payments and loss reserves growth.

Example 117 includes the subject matter of any of Examples 93-116, and wherein to select a model configured to inform decisions for strategic initiatives comprises to select a model configured to inform decisions for approving dividends, initiating or refinancing loan backs, or creating new risk lines.

Example 118 includes the subject matter of any of Examples 93-117, and wherein to select, as a function of the parameter data and from a set of models for tracking key financial metrics of different types of organizations, a model comprises to select a model configured for a higher education organization.

Example 119 includes the subject matter of any of Examples 93-118, and wherein to select a model configured for a higher education organization comprises to select a model configured to track one or more of grants, contracts, tuition, or student relief expenditures.

Example 120 includes the subject matter of any of Examples 93-119, and wherein to select, as a function of the parameter data and from a set of models for tracking key financial metrics of different types of organizations, a model comprises to select a model configured for a healthcare organization or a non-profit organization.

Example 121 includes the subject matter of any of Examples 93-120, and wherein to simulate an effect of a predicted performance of a set of investments on the financial status of the organization comprises to import investment market data from an external data source.

Example 122 includes the subject matter of any of Examples 93-121, and wherein to simulate an effect of a predicted performance of a set of investments on the financial status of the organization comprises to allocate compute resources as a function of a defined number of iterations of the simulation to execute.

Example 123 includes the subject matter of any of Examples 93-122, and wherein to simulate an effect of a predicted performance of a set of investments on the financial status of the organization comprises to allocate compute resources further as a function of a target time period in which to complete the simulation.

Example 124 includes the subject matter of any of Examples 93-123, and wherein to allocate compute resources comprises to allocate threads, cores, or virtual machines.

Example 125 includes the subject matter of any of Examples 93-124, and wherein to simulate an effect comprises to execute at least one Monte Carlo simulation.

Example 126 includes the subject matter of any of Examples 93-125, and wherein the instructions additionally cause the simulation system to execute thousands of iterations of a Monte Carlo simulation for the investments.

Example 127 includes the subject matter of any of Examples 93-126, and wherein to simulate an effect comprises to generate numerical representation of the simulated effect on the financial status of the organization.

Example 128 includes the subject matter of any of Examples 93-127, and wherein to generate a numerical representation comprises to generate a spreadsheet of the simulated effect on the key financial metrics of the organization.

Example 129 includes the subject matter of any of Examples 93-128, and wherein to simulate an effect comprises to generate a visual representation of the simulated effect.

Example 130 includes the subject matter of any of Examples 93-129, and wherein to generate a visual representation comprises to generate one or more charts indicative of the simulated effect.

Example 131 includes the subject matter of any of Examples 93-130, and wherein to simulate an effect comprises to generate a representation of probabilities associated with each of multiple possible outcomes.

Example 132 includes the subject matter of any of Examples 93-131, and wherein to generate a representation of probabilities comprises to generate a representation indicative of outcomes associated with each of multiple ranges of probabilities.

Example 133 includes the subject matter of any of Examples 93-132, and wherein to simulate an effect comprises to generate a representation of a projected performance of the investments relative to financial goals of the organization.

Example 134 includes the subject matter of any of Examples 93-133, and wherein the instructions additionally cause the simulation system to generate a representation indicative of whether the projected performance will satisfy the financial goals of the organization.

Example 135 includes the subject matter of any of Examples 93-134, and wherein to simulate an effect comprises to simulate performance of the investments over each of multiple years in a defined time period.

Example 136 includes the subject matter of any of Examples 93-135, and wherein to simulate an effect comprises to combine the simulated performance of the investments with a planned future financial performance of the organization.

Example 137 includes the subject matter of any of Examples 93-136, and wherein to simulate an effect comprises to combine a simulated performance of the investments with other investments of the organization.

Example 138 includes the subject matter of any of Examples 93-137, and wherein the system is associated with a financial institution, and wherein to combine a simulated performance of the investments with other investments of the organization comprises to combine the simulated performance with expected performance of a pension plan of the organization managed by the financial institution.

1. A system comprising:
circuitry configured to:
obtain parameter data indicative of a financial status of an organization;
select, as a function of the parameter data and from a set of models for tracking key financial metrics of different types of organizations, a model; and
simulate, using the selected model and by dynamically allocating compute resources across multiple compute devices as a function of a simulation compute load, an effect of a predicted performance of a set of investments on the financial status of the organization.

2. The system of claim 1, wherein to select, as a function of the parameter data and from a set of models for tracking key financial metrics of different types of organizations, a model comprises to select a model configured for an insurance organization.

3. The system of claim 2, wherein to select a model configured for an insurance organization comprises to: (i) select a model configured to one or more of inform decisions for strategic initiatives or project claims payments and loss reserves growth; and/or (ii) select a model configured to inform decisions for approving dividends, initiating or refinancing loan backs, or creating new risk lines.

4. The system of claim 1, wherein to select, as a function of the parameter data and from a set of models for tracking key financial metrics of different types of organizations, a model comprises to select a model configured for a higher education organization by selecting a model configured to track one or more of grants, contracts, tuition, or student relief expenditures.

5. The system of claim 1, wherein to select, as a function of the parameter data and from a set of models for tracking key financial metrics of different types of organizations, a model comprises to select a model configured for a healthcare organization or a non-profit organization.

6. The system of claim 1, wherein to simulate an effect of a predicted performance of a set of investments on the financial status of the organization comprises to allocate compute resources: (i) as a function of a defined number of iterations of the simulation to execute; and/or (ii) as a function of a target time period in which to complete the simulation.

7. The system of claim 6, wherein to allocate compute resources comprises to allocate threads, cores, or virtual machines.

8. The system of claim 1, wherein to simulate an effect comprises: (i) to execute thousands of iterations of a Monte Carlo simulation for the investments; (ii) to generate a numerical representation of the simulated effect on the financial status of the organization; (iii) to generate a representation of probabilities associated with each of multiple possible outcomes; (iv) to generate a representation indicative of outcomes associated with each of multiple ranges of probabilities; (v) to generate a representation of a projected performance of the investments relative to financial goals of the organization; and/or (vi) to simulate performance of the investments over each of multiple years in a defined time period.

9. The system of claim 1, wherein to simulate an effect comprises to simulate an effect comprises to combine the simulated performance of the investments with a planned future financial performance of the organization.

10. The system of claim 1, wherein to simulate an effect comprises to combine a simulated performance of the investments with other investments of the organization, wherein to combine a simulated performance of the investments with other investments of the organization comprises to combine the simulated performance with expected performance of a pension plan of the organization managed by the financial institution.

11. A method comprising:
obtaining, by a simulation system, parameter data indicative of a financial status of an organization;
selecting, by the simulation system and as a function of the parameter data and from a set of models for tracking key financial metrics of different types of organizations, a model; and
simulating, by the simulation system and using the selected model and by dynamically allocating compute resources across multiple compute devices as a function of a simulation compute load, an effect of a predicted performance of a set of investments on the financial status of the organization.

12. The method of claim 11, wherein selecting, as a function of the parameter data and from a set of models for tracking key financial metrics of different types of organizations, a model comprises selecting a model configured for an insurance organization.

13. The method of claim 12, wherein selecting a model configured for an insurance organization comprises: (i) selecting a model configured to one or more of inform decisions for strategic initiatives or project claims payments and loss reserves growth; and/or (ii) selecting a model configured to inform decisions for approving dividends, initiating or refinancing loan backs, or creating new risk lines.

14. The method of claim 11, wherein selecting, as a function of the parameter data and from a set of models for tracking key financial metrics of different types of organizations, a model comprises selecting a model configured for a higher education organization by selecting a model configured to track one or more of grants, contracts, tuition, or student relief expenditures.

15. The method of claim 11, wherein selecting, as a function of the parameter data and from a set of models for tracking key financial metrics of different types of organizations, a model comprises selecting a model configured for a healthcare organization or a non-profit organization.

16. The method of claim 11, wherein simulating an effect of a predicted performance of a set of investments on the financial status of the organization comprises allocating compute resources: (i) as a function of a defined number of iterations of the simulation to execute; and/or (ii) as a function of a target time period in which to complete the simulation.

17. The method of claim 16, wherein allocating compute resources comprises allocating threads, cores, or virtual machines.

18. The method of claim 11, wherein simulating an effect comprises: (i) executing thousands of iterations of a Monte Carlo simulation for the investments; (ii) generating a numerical representation of the simulated effect on the financial status of the organization; (iii) generating a representation of probabilities associated with each of multiple possible outcomes; (iv) generating a representation indicative of outcomes associated with each of multiple ranges of probabilities; (v) generating a representation of a projected performance of the investments relative to financial goals of the organization; and/or (vi) simulating performance of the investments over each of multiple years in a defined time period.

19. The method of claim 11, wherein simulating an effect comprises simulating an effect comprises combining the simulated performance of the investments with a planned future financial performance of the organization.

20. The method of claim 11, wherein simulating an effect comprises combining a simulated performance of the investments with other investments of the organization, wherein combining a simulated performance of the investments with other investments of the organization comprises combining the simulated performance with expected performance of a pension plan of the organization managed by the financial institution.
